(19) United States
(12) Patent Application Publication
(10) Pub. No.: US 2024/0017651 A1
(43) Pub. Date: Jan. 18, 2024

(54) CHILD SEAT WITH IMPACT SHIELD FOR MOUNTING ON A MOTOR VEHICLE SEAT

(71) Applicant: CYBEX GmbH, Bayreuth (DE)

(72) Inventors: Christoph THURN, Bayreuth (DE); Xu WEI, Lujia Town Kunshan (CN)

(21) Appl. No.: 18/250,951

(22) PCT Filed: Oct. 26, 2021
(86) PCT No.: PCT/EP2021/079594

§ 371 Date: Apr. 27, 2023

(30) Foreign Application Priority Data
Oct. 30, 2020 (DE) 20 2020 106 246.8

(51) Int. Cl. B60N 2/28

(52) U.S. Cl. CPC B60N 2/2839

(57) ABSTRACT

The invention relates to an impact shield for a child seat for mounting on a motor vehicle seat, the child seat having a main body for receiving a child, the impact shield having a first surface section, namely a head impact section, onto which the head of the child impacts in the event of sudden deceleration, the head impact section having at least one recess and/or being at least partially softer than at least a second surface section of the impact shield.

The invention relates to an impact shield for a child seat for mounting on a motor vehicle seat as well as to a corresponding child seat equipped with an impact shield.

Child seats with impact shields are known in principle.

Some of the features of such a child seat are described below, and these may also be realized in embodiments according to the invention.

The main body of such a child seat generally has at least one seating section, optionally also a back section (possibly including a headrest). Furthermore, a base, a support leg and/or further elements may be provided. The seating section and—if present—the back section and/or the headrest may comprise side parts which may give the main body a shell-like character (seat shell). The main body of a child seat may further comprise, for example, at least one side impact protection, at least one belt guide and/or at least one anchorage element (e.g. Isofix anchorage element or LATCH anchorage element) and/or further elements. The seating section of the main body may have a seat surface for accommodating the buttocks, possibly also legs or leg sections of a child (or dummies, in particular dummies of the Q or P series) accommodated in the child seat, as well as right and left lateral areas, which may also be designed as side parts. If necessary, the side parts can also be formed in such a way that a receptacle opening (which can have the shape of small horns) between an upper section (in an armrest-like manner connected to the seating section with a rear area) and a lower section (essentially continuing the seat surface to the side) results. The main body, in particular the seating section, can have at least one first fastening means (e.g. a right and a left fastening element) for fastening an impact shield.

An impact shield (of conventional construction, although some or all of the following features may also apply to the impact shield according to the invention) is rigid, at least in sections, and is designed to restrain a child in a child seat. For this purpose, the impact shield generally has a middle section (in relation to a lateral extent) which is designed to restrain a child, in particular a pelvic, abdominal and/or chest area of the child, as well as a right and a left lateral section each which is designed in particular for support on lateral areas of the seating section (possibly on the side parts). Alternatively or additionally, the lateral sections may be provided as connecting parts which are provided for (positive) engagement in a (respective) receptacle (possibly the above receptacle opening of the seating section) provided for this purpose (see, for example, GB 2 266 839 A). Where appropriate, the impact shield may comprise at least a second fastening element for cooperating with the first fastening element of the main body to enable a fastening of the impact shield to the main body. Advantageously, the impact shield is be at least in sections energy-absorbing and/or made of a deformable, in particular plastically deformable material (for example EPP or EPS or EPO) (cf. EP 3 626 518 A1). The impact shield can have additionally or preferably alternatively to the second fastening element a belt guide for a vehicle belt (in particular for fastening the impact shield to the main body and/or for fastening the impact shield and main body together to the vehicle seat).

Generally (in particular also in embodiments according to the invention), the impact shield or its middle section may have an inner side (facing the child's pelvis/abdomen or chest in proper use) and a underside (facing the child's legs or a leg section in proper use). The impact shield can also have an outer side (at least substantially) opposite the inner side, as well as an upper side (at least substantially) opposite the underside, so that at least in sections, in particular in the middle area, there can be, for example, a rectangular, possibly parallelogram- or trapezoid-shaped, possibly also oval or round cross-section.

The solutions known in the state of the art are considered to be in need of improvement from a constructional or safety point of view.

It is therefore a particular object of the invention to propose an impact shield or a corresponding child seat with an impact shield which can hold the child securely in the child seat or on the vehicle in a comparatively simple manner. In particular, risks in connection with accelerations of the child in a frontal accident are to be reduced as far as possible.

In particular, the object is solved by claim 1.

In particular, the object is solved by an impact shield for a child seat for mounting on a motor vehicle seat, wherein the child seat has a main body for accommodating a child, wherein the impact shield has a first surface section, namely a head impact section, onto which the head of the child impacts in the event of a strong deceleration, wherein the head impact section has at least one recess and/or is at least partially formed softer than at least a second surface section of the impact shield.

A core idea of the invention is to form a head impact section on which the child's head impacts in the event of a strong deceleration (that is in particular in the event of a frontal impact or frontal accident) to be comparatively soft and/or to be provided with a recess or, according to an even more general idea of the invention, to form in such a way that it offers comparatively little resistance to the impacting head and/or interacts with the head only as late as possible (when the movement of the head is already very far advanced). In particular, it has been recognised in accordance with the invention that in the event of a frontal impact, the child's head can impact on the impact shield, in particular its upper side, in such a way that a risk of injury results therefrom. In particular, this can significantly increase the risk of injury to the child. Furthermore, it has also been taken into account that it can generally be considered advantageous to dimension the inner side of the impact shield comparatively large, or large enough for the impact shield to restrain the abdomen and chest of the child (at least the smallest child approved for the use of the child seat), in order to enable the distribution of possible restraining forces over as large an area as possible. The underside can usually also be dimensioned in such a way that it (at least approximately) covers the thighs of the child (at least the smallest child approved for use of the child seat), which has proven to be stabilising in various accident scenarios (for example in the event of a rollover).

In particular, it was taken into account or recognised according to the invention that the impact of the child's head on the impact shield (unless the head can be restrained at a very early stage of the accident) is comparatively problematic, as this increases stress and the risk of injury to the child.

Preferably, the impact shield has no active protective device (or at least no inflatable airbag). However, the impact shield can optionally be equipped with an active protective device (or an airbag).

By a surface section shall be understood in particular a section comprising an (outer surface). The (respective) surface section can also be understood (in particular when it comes to material properties) as a three-dimensional section, whereby a depth of the surface section can be set to at least or exactly 1 cm or at least or exactly 2 cm and/or at most 10 cm or at most 5 cm (which does not have to mean—but can mean—that there is a structural limit at the corresponding depth; here, it is in particular a matter of a specification by means of which different surface sections can be compared with one another). A possible cover and/or another (comparatively thin, possibly dimensionally unstable or dimensionally stable) covering should preferably be disregarded, but can also be taken into account (especially if such a covering also co-forms or follows the recess and/or contributes significantly to a comparatively soft formation).

In addition to the features already presented introductorily, the impact shield can be characterised by further features. Preferably, an impact shield shall be understood as a device which is (preferably at least in sections detachably, in particular removably) fastenable to the main body of the child seat in order to hold the child to the main body. The impact shield is preferably (at least partially) dimensionally stable (in particular in the sense that it does not collapse under its own weight and/or when subjected to only minor external forces).

The impact shield may be made of plastic (at least prosectionally, for example at least 80% by weight) and/or comprise a cushion (for example foam cushion). At least 30% by weight, preferably 60% by weight, of the impact shield may be formed of a solid and/or non-porous material (plastic). The impact shield may be formed at least of 30% by volume, preferably at least 60% by volume, of a porous material (in particular foamed plastic, e.g. EPS or EPP). The impact shield may weigh at least 200 g or at least 500 g and/or at most 5 kg or at most 2 kg.

The impact shield may comprise at least one guiding device for guiding a vehicle belt (and/or other belt, for example a belt mounted or mountable on the main body) in such a way that the impact shield (in particular both the main body as well as the impact shield) can be attached to the vehicle seat or the impact shield can be attached to the main body.

The child seat is preferably configured for forward-facing arrangement on the vehicle seat (so that the child faces in the direction of travel). By a direction of travel (forward direction) is meant in particular a movement of the vehicle in a straight-ahead direction, since a child seated in the child seat (when facing straight ahead) faces in the direction of travel. When the (straight ahead) moving vehicle is subjected to (sudden) deceleration, for example due to a frontal accident, the child and child seat are subjected to inertial forces acting in the direction of travel.

A (normal) use situation shall be understood to mean in particular a situation where the impact shield is arranged (mounted) on the main body (in particular according to the instructions of the child seat manufacturer) and where a child can be safely supported by the childe seat and held by it or its impact shield (in particular according to the instructions of the child seat manufacturer).

A sudden deceleration (or an event with a sudden deceleration) shall be understood to mean, in particular, an event in which high accelerations (or decelerations) occur compared to a normal journey in a vehicle (e.g. passenger car). In particular, a collision (frontal impact) or other accident shall be understood as an event with sudden deceleration. In particular, such a deceleration can be understood as a sudden deceleration event if the accelerations (or decelerations) are such that an active protective device, such as an airbag, is triggered in the motor vehicle. Decelerations during a sudden deceleration event may possibly exceed 2 g, possibly even 3 g or even 5 g or even 8 g (or, if these limits are exceeded, be understood as a corresponding event with sudden deceleration). In particular, an impact (“crash”) as described as a “frontal crash” in UN ECE-R44 or in UN ECE-R129 (valid at the time of application or priority, respectively, retrievable e.g. from the UNECE website www.unece.org) shall be understood as a sudden deceleration event.

A head impact section shall be understood in particular as a section of the impact shield onto which the child's head impacts in the event of a (sudden) deceleration (or would impact in the event of an even greater deceleration—according to some embodiments, the head impact section should have a recess so that the head does not impact at all or at least particularly late).

This area can preferably be determined by a Q-dummy, as in UN ECE-R129 (valid on the application or priority date of the present description and/or on 31 Dec. 2013). Q-dummies exist in the sizes Q0, Q1, Q1.5, Q3, Q6 and Q10, where the number after the Q indicates the (approximate) age of the child to which the dummy should correspond.

In particular, the present seat or its impact shield is intended to be approved for children from a minimum height to a maximum height, wherein the minimum height may be at least 60 cm, preferably at least cm, and/or the maximum height may be at most 130 cm, preferably at most 116 cm. Alternatively or additionally, the seat may be designed at least for dummies (or children which are replicated by the corresponding dummies) from Q1 or Q1.5 to Q6.

The mentioned standard UN ECE-R129 can be specifically the “Regulation No. 129—Uniform provisions concerning the approval of enhanced child restraint systems used on board of motor vehicles (ECRS)” or E/ECE 324/Rev.2/Add.128-E/ECE/Trans.505/Rev.2/Add.128, for example valid as of 9 Jul. 2013 and/or 31 Dec. 2013 and/or just at the priority or application date).

Specifically, the dummies of the manufacturer Humanetics can be used as dummies. Additional information can be found in the manuals of the manufacturer Humanetics (to which the standard UN ECE-R129 also refers).

Preferably, the head impact section is defined by a section of the upper side of the impact shield. In so far as the head impact section is not specifically defined (for example, taking into account a dummy as explained above), also, alternatively, an area of the child seat referred to above which extends from the inner side of the impact shield (or its upper edge) (possibly at a distance of at least 2 cm or at least 5 cm from this edge) forwards over approximately (in the maximum extension in the front-to-rear direction) at least 5 cm and/or at most 25 cm or at most 15 cm may be considered as the head impact section. A (maximum) transverse extension (perpendicular to the front-to-rear direction) of the head impact section may also be at least 5 cm or at least 10 cm and/or at most 25 cm, preferably at most 15 cm. The recess or the comparatively soft section may lie entirely within a head impact section defined in this way or may also extend beyond it (but preferably by no more than 5 cm). Alternatively or additionally, the (entire) upper surface of the impact shield may also be considered as head impact section.

A surface section shall be understood as softer compared to another surface section if it offers less resistance to an impact of the child's head. For example, a spherical test specimen may depress the softer surface section (when that surface section is aligned horizontally and the test specimen is resting on it) deeper (further) than in the case of the comparison surface section (to which reference is made). Such a test ball may, for example, have a weight of 2 kg and/or a diameter of 10 cm or correspond in shape (or at least diameter) and weight to the head of one of the dummies mentioned above. If a given structure of an impact shield does not allow such a measurement, it can first be determined (or checked) of which material the respective section is formed. Then a test specimen can be formed which is sufficiently wide, long and deep (for example, at least 30 cm wide and long, as well as 10 cm deep) to enable the measurement explained above to be carried out. In the case of an elastic deformability of the respective surface sections to be compared, that surface section is to be understood as softer which has a lower modulus of elasticity (in particular at 20°, at least in a direction perpendicular to the respective surface), which preferably corresponds to at most 0.8 times, still further preferably at most 0.5 times that modulus of elasticity (or its comparison section). If the respective surface section consists of several materials, this shall preferably apply to at least those materials which immediately adjoin the respective surface. A possible cover or other (comparatively thin, possibly dimensionally unstable or dimensionally stable) covering should preferably be not taken into account, but can also be taken into account (especially if such a covering also forms or follows the recess and/or contributes significantly to a comparatively soft formation).

In embodiments, the recess is not covered.

In alternative embodiments, the recess may also be covered (at least partially, possibly completely) by means of a cover. The cover preferably has a thickness of at least 0.1 mm, optionally at least 1 mm and/or at most 5 cm, preferably at most 3 cm or at most 1 cm.

At least one (or the at least one) second surface section may comprise, at least in sections, a surface section adjacent to the head impact section. The same second surface section or at least one further second surface section may (alternatively or additionally) comprise, at least in sections, an inner side surface section arranged on an inner side of the impact shield.

In embodiments, the second surface section may comprise at least the entire inner side, optionally also the (entire) underside, of the impact shield (or the surface thereof). Alternatively or additionally, the second surface section may be designed in such a way that it does not comprise a belt guide for the vehicle belt and/or sections of the impact shield forming connecting parts and/or fastening means.

In principle, the head impact section or first surface section can be formed softer than all other surface sections of the impact shield (or at least softer than all surface sections of an inner side and/or outer side and/or underside and/or left side and/or right side). However, according to the embodiment, in particular a section of the inner side directed towards the abdomen of the child can also be softly formed.

The head impact section may be formed at least in sections (possibly completely) from a first material. The at least one second (or one of possibly several second) surface section(s) can be formed at least in sections from a second material. Insofar as the head impact section and/or the second surface section comprise more than one material, the first or second material shall be understood in particular as that material which constitutes at least 20% or at least 50% or at least 80% of the surface which the surface section forms. In embodiments, the first and second materials preferably differ from one another.

The first material may have a lower modulus of elasticity than the second material (for example, a modulus of elasticity that is at most 0.8 times, preferably at most 0.5 times, optionally at most 0.2 times, as high as the modulus of elasticity of the second material).

Alternatively or additionally, the first material may have a higher porosity than the second material. The porosity of the first material may be at least 1.2 times, preferably at least 1.5 times, still further preferably at least 2 times as large as a porosity of the second material. In some embodiments, the second material is non-porous (that is has at least substantially no pores).

Alternatively or additionally, the first material may have a different chemical composition than the second material (for example, be made of a different plastic).

Alternatively or additionally, the first material may have a lower density than the second material.

The first material may be a foam or foamed material and/or the second material may be a dense or non-foamed material. The second material may also be a foamed material, e.g. a particle foam.

To the extent that the recess is (at least partially) covered by a cover, the cover may be integrally formed (in particular in the same process as the surrounding section that also forms the recess itself). The cover can also be (at least partially) applied subsequently, in particular fixed, for example glued on. A cavity (or, in general, a depth of the recess) thus obtained can preferably be at least 2 cm, possibly at least 3 cm or 5 cm deep. Alternatively or additionally, the cover may preferably be at most 5 cm thick, preferably at most 2 cm or at most 1 cm.

The recess may have a depth of at least 2 cm, preferably at least 3 cm or at least 5 cm and/or at most 10 cm.

The recess may be formed by a clearance which (apart from an optional cover) is open at the top and closed laterally (in particular to the right and left).

In alternative embodiments, the recess can be formed by a clearance which (apart from an optional cover) is open at the top and on at least (or exactly) one or at least (or exactly) two, in particular opposite sides, preferably a left and a right side (and in particular closed at the bottom, possibly on the remaining side(s)). Such a clearance can also be designed as an open (to the side) channel or as a (possibly rounded) step. In particular, such a clearance can be visible in a (vertical) side view (from the left and/or right).

The recess may have a constant depth in at least one direction (for example, in the transverse direction from right to left or vice versa). The indication “right” is always to be understood as a side to which the child's right shoulder is adjacent (analogously applies to the left side).

In total (in the head impact section) at least (or exactly) one recess or at least (or exactly) two recesses or three or more recesses may be formed (which are separated from each other, for example, by bars).

In total (in the head impact section) at least (or exactly) one softer section or at least (or exactly) two softer sections or three or more softer sections may be formed (which are separated from each other, for example, by bars or less soft areas).

The at least one recess (optionally several or all recesses in their entirety) and/or the at least one softer section (optionally several or all softer sections in their entirety) may extend over an area of at least 10 cm², preferably at least 30 cm² and/or at most 400 cm², preferably 250 cm².

The (respective) recess and/or the (respective) softer section may have a distance of at least 2 cm and/or at most 10 cm from an upper edge of an inner side of the impact shield and/or a rear edge of an upper side of the impact shield. Alternatively or additionally, the (respective) recess and/or the (respective) softer section may have a distance of at least 2 cm and/or at most 10 cm from a front edge of a (the) upper side.

According to a basically independent (but preferably disclosed and claimed in combination with one or more of the above aspects) aspect of the invention, the object is particularly by an impact shield (in particular of the above type) for a child seat for mounting on a motor vehicle seat, wherein the child seat has a main body for accommodation of a child, wherein an upper side of the impact shield slopes forward at least in sections in at least one state of use, wherein an angle relative to the horizontal and/or an underside of the impact shield is preferably at least in sections greater than 20°, preferably is greater than 30°, optionally is greater than 40°. Alternatively or additionally, at least one rear point of the upper side of the impact shield lies by at least 20%, preferably at least 30% or at least 50%, of a height (vertical extent) of the impact shield above a level of at least one relative to the rear point forward point of the upper side lies. The respective points to be considered preferably lie in the same vertical plane oriented in the forward direction (=vertical forward plane), further preferably in a central vertical forward plane relative to the impact shield. The rear point preferably lies in a rear half (in particular rear third) of the impact shield and/or the front point in a front half (in particular front third) or a middle third. The indications of the preceding sentence refer in particular to an extension of the impact shield in the forward direction. For example, a point shall be located in a rear half if, in a projection onto the horizontal plane, it is located behind a centre point or behind a centre line (which extends sideways) of the impact shield projected onto the same horizontal plane. Any smaller holes or clearances, for example for fastening purposes, should preferably not be taken into account in this consideration (for example if these holes or clearances have a cross-section—in particular transverse to a depth dimension—of less than 5 cm² or less than 2 cm²). The aspects of this paragraph may also particularly preferably be combined with one or more of the appended claims (wherein the features of claim 1 need not be realised, but may be realised). In principle, this aspect can be combined with all features which are described above (and below), whereby then the above explained recess and/or soft section need not necessarily be formed.

A core idea of this further aspect of the invention is to provide, in deviation from known forms, an impact shield which slopes comparatively steeply. Also by this it is achieved that the child's head (at least in a comparatively late phase of the accident) does not impact in such a way that injuries result (or at least a probability of this is reduced).

Insofar as an angle relative to an underside of the impact shield is defined and this underside should not be straight, a plane is to be used which results when the impact shield is placed with its underside on a flat floor surface. The respective angle specification is fulfilled by at least 20 area %, further preferably at least 50 area %, optionally at least 80 area %. In embodiments, the respective angle may even be greater than 50° or even greater than 60°.

If an upper side of the impact shield slopes forward at least in sections in at least one state of use, an angle relative to the horizontal and/or an underside of the impact shield may be smaller than 85° at least in sections (in particular in the sections which satisfy the above requirement of a lower limit), preferably smaller than 80° or optionally smaller than 70° or even smaller than 60°.

The above-mentioned object is further solved by a child seat comprising an impact shield according to at least one of the above aspects.

In at least one state of use, an upper side of the impact shield can slope forward at least in sections, wherein an angle relative to the horizontal and/or an underside of the impact shield is preferably at least in sections greater than 20°, further preferably greater than 30°, optionally greater than 40° or even greater than 50° and/or less than 85°, preferably less than 80°, optionally less than 70° or even less than 60°.

At least one rear point of the upper side of the impact shield may be by at least 20%, preferably at least 30% or at least 50%, of a height of the impact shield above a level of at least one relative to the rear point front point of the impact shield.

The head impact section is in particular (completely) arranged in a middle section of the impact shield which is not part of the inner side or underside of the impact shield (or forms the inner side/underside). Preferably, the head impact section is part of (or defined by) the upper side of the impact shield. If necessary, the entire upper side of the impact shield can be understood as head impact surface.

Preferably, the upper surface of the impact shield is intended and configured to be contacted by and/or to catch the child's head in the event of a frontal impact. In particular, an edge of the head impact section closest to the inner side of the impact shield (as viewed in the direction of travel) may be at a distance of at most 10 cm, further preferably at most 7 cm or at most 5 cm from the inner side.

According to a general idea of the invention, the impact shield may comprise a first section forming a first side of the impact shield, wherein the first section absorbs a smaller part of (in particular perpendicular) acting forces than a second section of the body, wherein the second section is preferably adjacent to the first section and/or wherein the second section preferably forms at least parts of the inner side of the impact shield.

The first section may be part of or form a top surface of the impact shield.

The first section may be formed softer than the second section of the impact shield.

An upper edge of the inner side may be higher (at least in at least one state of use) than an upper edge of an outer side by at least 3 cm, preferably at least 5 cm, still further preferably at least 10 cm, optionally cm and/or at most 20 cm.

The impact shield may have on its upper side (entirely or at least in the region of the head impact section) a narrow rear section adjoining the inner side (wherein narrow in particular refers to an extension in the direction of travel and/or wherein narrow preferably can mean less than cm, in particular less than 7 cm, for example 3-5 cm), and a front part further away from the inner side, wherein the front part is offset downwards relative to the rear part, preferably by at least 2 cm (optionally by at least 3 cm or 5 cm).

The recess may have a polygonal, for example quadrangular (specifically rectangular or trapezoidal) shape in a plan view. Furthermore, the recess may have (in a plan view) a sector shape, with a vertex of the sector preferably being the rearmost point. By this the safety for the child can be improved particularly effectively. Alternatively, the recess may have an oval (in particular elliptical or round) shape in plan view.

If, in the present context, a position of use or a state of use of the impact shield (in particular with regard to possibly defined angles) is important, the respective parameter shall be fulfilled in particular for at least one possible state of use if several states of use can be set (for example if the impact shield and/or a part of the child seat on which the impact shield is mounted can be changed with regard to its angular position), preferably for at least half the total adjustable angular range (with regard to the orientation of the impact shield relative to the horizontal). The starting point is preferably the impact shield or child seat in a state in which the child seat is placed on a horizontal flat surface.

Further embodiments result from the dependent claims.

In the following, the invention is described by means of execution examples which are explained in more detail with reference to the figures. Hereby show:

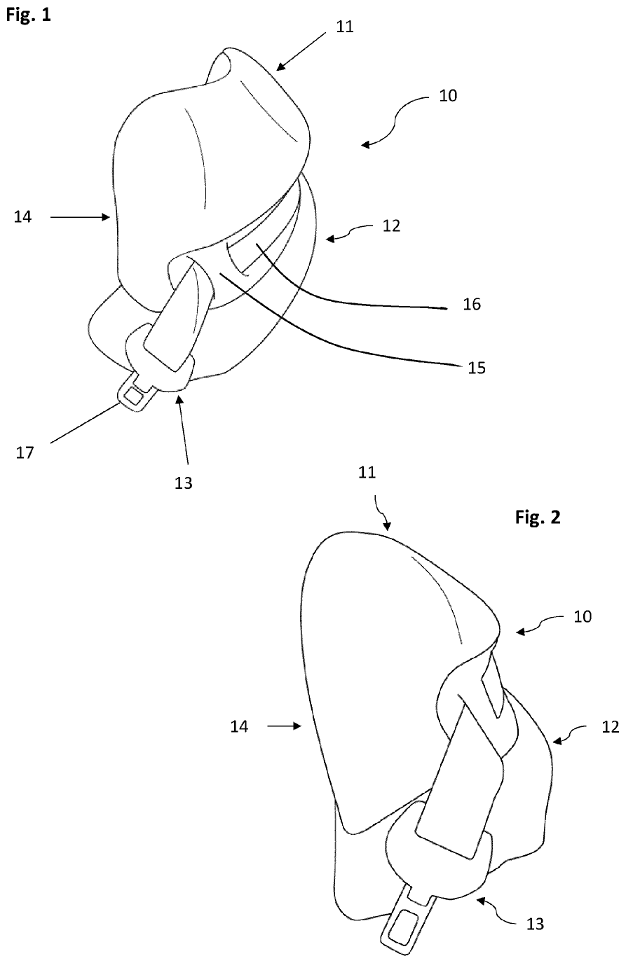

FIG. 1 a first embodiment of an impact shield according to the invention in an oblique view;

FIG. 2 a further embodiment of an impact shield according to the invention in a side view;

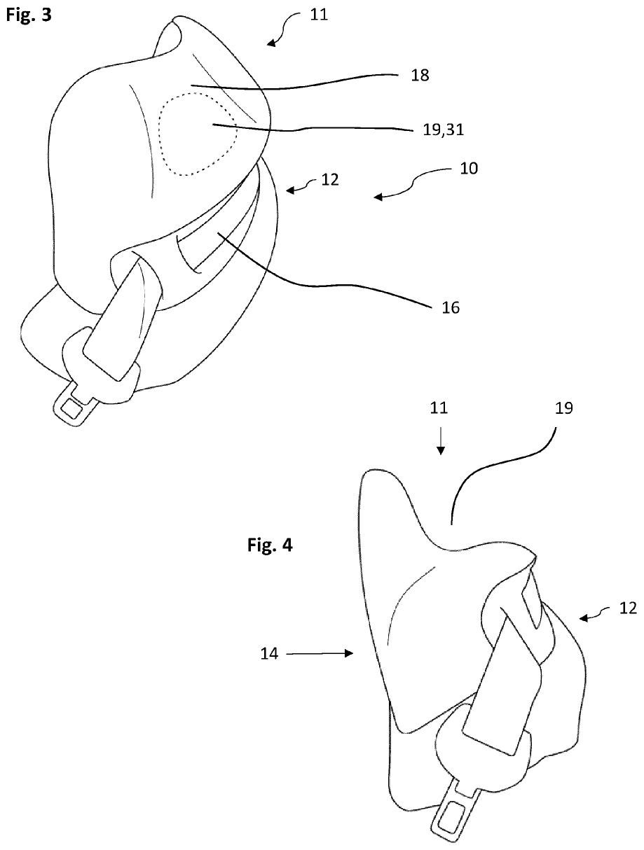

FIG. 3 an embodiment analogous to FIG. 1 with schematically sketched head impact surface;

FIG. 4 a side view of a further embodiment of an impact shield according to the invention;

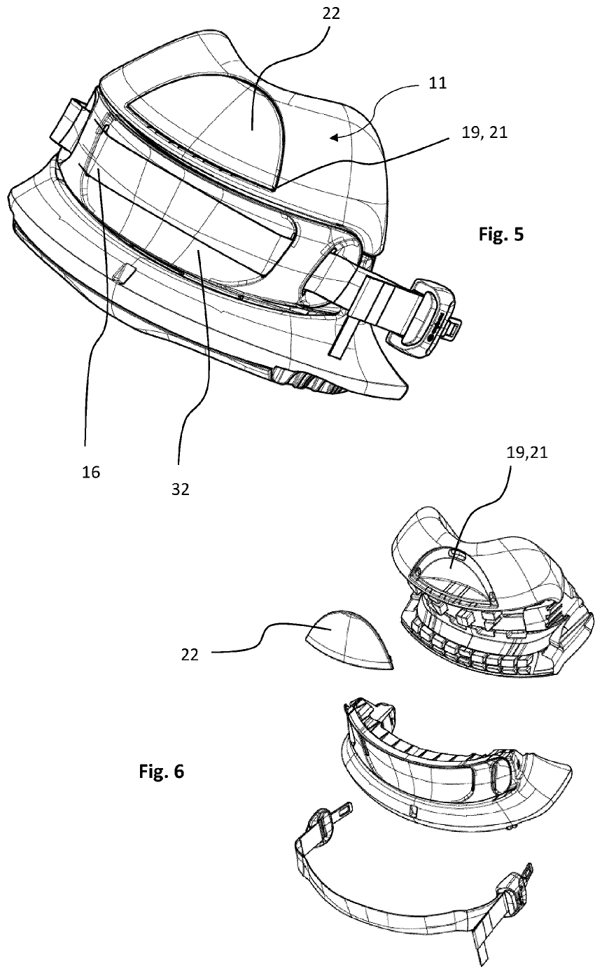

FIG. 5 an oblique view of a further impact shield according to the invention;

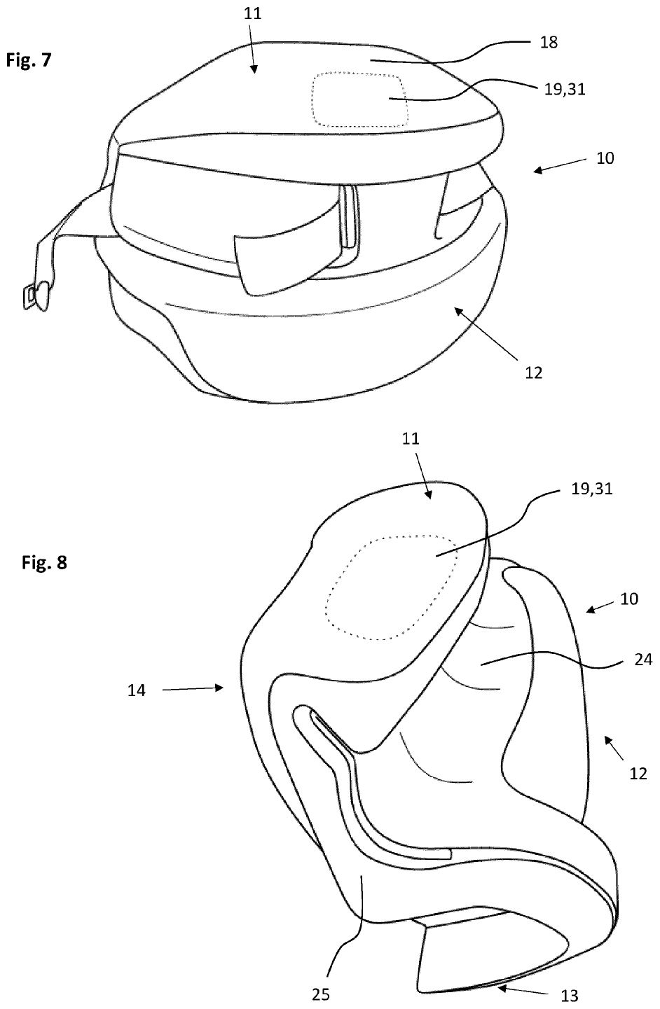

FIG. 6 an exploded view of the impact shield according to FIG. 5;

FIG. 7 a further embodiment of an impact shield according to the invention in an oblique view;

FIG. 8 a further embodiment of an impact shield according to the invention in an oblique view;

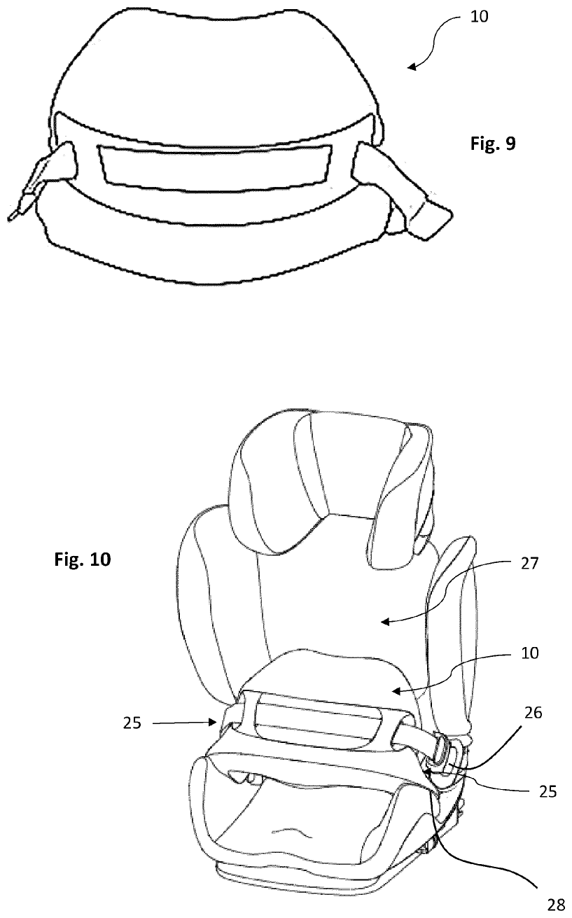

FIG. 9 the impact shield according to FIG. 2 in a front view;

FIG. 10 a child seat according to the invention; and

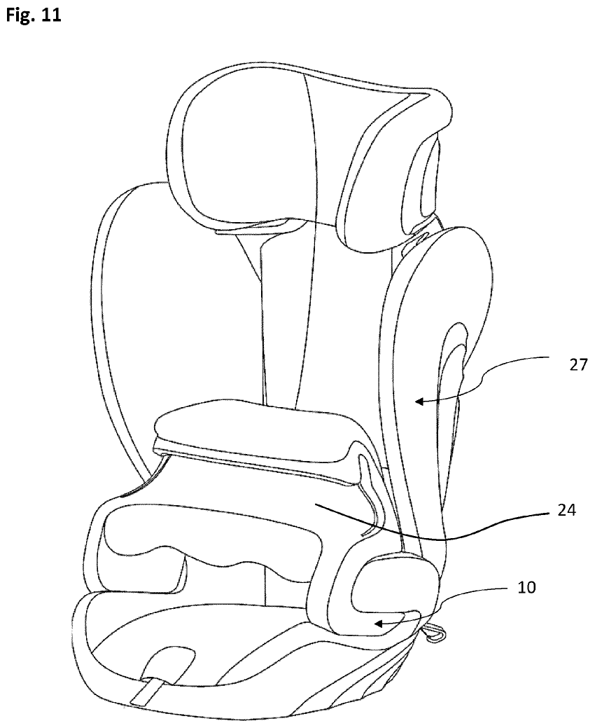

FIG. 11 a further embodiment of a child seat according to the invention.

In the following description, the same reference numerals are used for identical and similarly acting parts.

FIG. 1 shows an impact shield 10 with an upper side 11, an outer side 12, an underside 13 and an inner side 14. At least one belt guiding mechanism (specifically in the form of an eyelet or belt) is formed on the outer side 12, via which a belt section 16 can be guided or held. The belt section 16 can in turn be fastened to a main body (not shown here) of a child seat via a fastening means 17 (e.g. belt tongue) (see also FIG. 10).

Specifically, the belt section 16 can be guided (at least substantially) across the impact shield.

The impact shield according to FIG. 1 has a comparatively steep upper side 11. Specifically, the upper side 11 has an angle of more than 45° relative to a horizontal (in the mounted state of the impact shield, cf. FIG. 10).

The embodiment shown in FIG. 1 may have a recess and/or a softer section (as explained below, for example, with reference to FIG. 3). However, this need not be the case.

FIG. 2 shows a side view of a further embodiment of an impact shield according to the invention. Here (in contrast to FIG. 1) the upper side 11 slopes somewhat less steeply. Here, too, a recess and/or a softer section may (but need not) be provided, as explained, for example, in connection with FIG. 3.

FIG. 3 shows an oblique view of an impact shield according to the invention. In a head impact section 18, at least one recess 19 and/or at least one softer section 31 is formed (the outline of which is drawn in dashed lines). The softer section is preferably softer than at least one section which is adjacent to the dashed area from the outside. If applicable, the entire upper surface may be formed softer (at least compared to an inner side). This head impact section 18 may be entirely (or at least partially, for example at least 50 area % relative to a plan view or at least 80 area % relative to a plan view) formed by one or more recesses and/or one or more softer section(s).

FIG. 4 shows a further embodiment of an impact shield according to the invention in side view. Here, a recess 19 is formed which is open towards the top and towards the two sides (that is towards the left and right) or is formed as a (rounded) step. Specifically, the upper side 11 (starting from its highest point in the position of use) is initially (over a comparatively short section) formed only slightly sloping, then has a section with a steep slope (with an angle of more than 60°, or possibly even more than 70° relative to the horizontal), to then slope again less steeply until there is even (optionally) a (but rather slight) rise again with an angle of between 10 and 40° relative to the horizontal. In an end section or foremost section of the upper side, the angle (optionally) reverses again and the upper side slopes again.

FIG. 5 shows a specific embodiment of an impact shield according to the invention in an oblique view.

The impact shield comprises a main body (preferably made of EPP) with a cavity 21, which is covered by a cover 22 (for example made of EPP). This cavity also forms a corresponding recess 19 (which is covered here). Furthermore, the impact shield according to FIGS. 5 and 6 has a belt guide 32 made of hard plastic as well as a belt (section) 16. FIG. 6 shows the impact shield according to FIG. 5 in an exploded view.

A specific alternative (but not shown) embodiment results when the cavity of the impact shield according to FIG. 5 is not covered by the cover 22, but is filled with a softer (compared to the material, e.g. EPP, of the main body) foam. Analogously applies to the other figures.

In the embodiment according to FIG. 7, an upper side 11 of the impact shield is formed only slightly sloping. In a head impact section 18, a recess 19 and/or a softer section 31 may/may be arranged, as indicated by dashed lines. These can be formed, for example, as explained in connection with FIG. 3.

FIG. 8 shows an oblique view of a further embodiment of the impact shield. Here, too, a head impact section 18 is shown schematically. This can also be designed as explained in connection with FIG. 3. The upper side 11 is formed here (at least approximately) horizontal. The impact shield can have a belt guide 24 for a vehicle belt (not shown), by means of which the main body can be held together with the impact shield on the vehicle seat. Furthermore, lateral sections 25 of the impact shield can be designed for positive engagement in side parts (in the shape of small horns) of the main body.

FIG. 9 shows a front view of the impact shield according to FIG. 2, whereby the head impact section is not explicitly shown here.

FIG. 10 shows a child seat according to the invention with impact shield 10. The impact shield 10 is attached to a main body 27 of the child seat by means of a fastening belt 26 and is supported on the main body (namely at the corresponding lateral sections 25) relative to a support surface 28 (respectively or arranged on the right and on the left).

FIG. 11 shows a child seat according to the invention with impact shield 10. The impact shield 10 is designed here for fastening to a main body 27 of the child seat with a vehicle belt, which is not shown, and has a belt guide 24 for this purpose. The lateral sections of the impact shield are in positive engagement with the small horns of the main body of the child seat.

At this point, it should be noted that all of the parts described above, taken individually and in any combination, in particular the details shown in the drawings, are claimed as essential to the invention. Modifications thereof are familiar to the skilled person.

Furthermore, it is pointed out that the broadest possible scope of protection is sought. In this respect, the invention defined in the claims can also be specified by features which are described with further features (even without these further features necessarily being included). It is explicitly pointed out that round brackets and the term “in particular”/“particularly” are intended to emphasise the optionality of features in the respective context (which does not mean, conversely, that a feature is to be regarded as mandatory in the corresponding context without such identification).

### REFERENCE SIGNS

10 impact shield
11 upper side
12 outer side
13 underside
14 inner side
15 belt guiding mechanism
16 belt section
17 fastening means
18 head impact section
19 recess
21 cavity
22 cover
24 belt guide
25 lateral section
26 fastening belt
27 main body
28 support surface
31 softer section
32 belt guide

1. An impact shield for a child seat for mounting on a motor vehicle seat,
wherein the child seat has a main body for accommodating a child,
wherein the impact shield has a first surface section including a head impact section, against which the head of the child impacts in the event of sudden deceleration,
wherein the head impact section has at least one recess or is formed at least partially softer than at least a second surface section of the impact shield.

2. The impact shield according to claim 1,
wherein
the recess is not covered or is covered by means of a cover, wherein the cover has a thickness of 0.1 mm to 5 cm.

3. The impact shield according to claim 1,
further including
at least a second surface section comprising, at least in sections, a surface section adjacent to the head impact section or, at least in sections, an inner side surface section arranged on an inner side of the impact shield.

4. The impact shield according to claim 1,
wherein
the head impact section is formed at least in sections from a first material and at least a second surface section is formed at least in sections from a second material,
wherein the first and second materials differ in that the first material has a lower modulus of elasticity than the second material or in that the first material has a higher porosity than the second material or by a chemical composition.

5. The impact shield according to claim 1,
wherein
the recess has a depth of 2 cm to 10 cm.

6. The impact shield according to claim 1,
wherein
the recess is formed by a clearance open at the top and closed at the sides.

7. The impact shield according to claim 1,
wherein
the recess is formed by a clearance open at the top and open on opposite sides and otherwise closed on.

8. The impact shield according to claim 1,
wherein
the recess or the softer section extends over an area of 10 cm² to 400 cm².

9. The impact shield according to claim 1,
wherein
the recess or the softer section has a distance of 2 cm to 10 cm from an upper edge of an inner side of the impact shield and a rear edge of an upper side of the impact shield or has a distance of 2 cm to 10 cm from a front edge of an upper side.

10. The impact shield according to claim 1, for a child seat for mounting on a motor vehicle seat, wherein the child seat comprises a main body for accommodating a child,
wherein
an upper side of the impact shield in at least one state of use slopes towards at least in sections, wherein an angle relative to horizontal and an underside of the impact shield at least in sections is greater than 20°, or
wherein at least one rear point of the upper side of the impact shield lies by at least 20%, of a height of the impact shield above a level of at least one relative to the rear point front point of the upper side.

11. The impact shield according to claim 1,
wherein
an upper side of the impact shield in at least one state of use slopes forward at least in sections, wherein an angle relative to horizontal and an underside of the impact shield at least in sections is smaller than 80° or
wherein there is no rear point of the upper side of the impact shield which is more than 80% of a height of the impact shield above a level of all relative to the rear point front points of the upper side.

12. A child seat comprising an impact shield according to claim 1.

13. The child seat according to claim 12,
wherein
an upper side of the impact shield in at least one state of use slopes forward at least in sections, wherein an angle relative to horizontal and an underside of the impact shield at least in sections is 20° to 80°,
or
wherein at least one rear point of the upper side of the impact shield lies by 20% to 50%, of a height of the impact shield above a level of at least one relative to the rear point front point of the impact shield.
